(19) United States
(12) Patent Application Publication
(10) Pub. No.: US 2009/0120212 A1
(43) Pub. Date: May 14, 2009

(54) NOy and Components of NOy by Gas Phase Titration and NO2 Analysis with Background Correction

(76) Inventors: James Hargrove, (US); Jingsong Zhang, (US)

Correspondence Address: LOZA & LOZA LLP, 305 N. SECOND AVENUE, #127, UPLAND, CA, 91786-6064, US

(21) Appl. No.: 12/269,627

(22) Filed: Nov. 12, 2008

Related U.S. Application Data
(60) Provisional application No. 60/987,688, filed on Nov. 13, 2007.

(51) Int. Cl. G01N 1/22

(52) U.S. Cl. 73/863.11

(57) ABSTRACT

A method for quantifying nitrogen-containing species from an atmospheric sample includes introducing the atmospheric sample into an NO₂-analyzer to obtain a first measurement; subjecting the atmospheric sample to thermal decomposition followed by introducing the atmospheric sample into the NO₂-analyzer to obtain a second measurement; subjecting the atmospheric sample to ozone titration and thermal decomposition followed by introducing the atmospheric sample into the NO₂-analyzer to obtain a third measurement; subjecting the atmospheric sample to excess ozone followed by introducing the atmospheric sample into the NO₂-analyzer to obtain a fourth measurement; and subjecting the atmospheric sample to a catalyst at an elevated temperature followed by introducing the atmospheric sample into the NO₂-analyzer to obtain a fifth measurement.

### CLAIM OF PRIORITY

This application claims the benefit of U.S. Provisional Patent Application No. 60/987,688 filed Nov. 13, 2007.

### STATEMENT OF GOVERNMENT INTEREST

This invention was made with Government support under grant number CHE-0416244 awarded by the National Science Foundation. The Government has certain rights in this invention.

### FIELD OF INVENTION

The present invention relates to measuring atmospheric nitric oxide (NO), nitrogen dioxide (NO₂) and other inorganic nitrates and alkyl nitrates including peroxyacetyl nitrates (PANs), ammonia (NH₃) and nitrous oxide (N₂O) and ozone (O₃) free from other atmospheric constituents.

### BACKGROUND OF INVENTION

Air is a mixture of gases approximately composed of 78.08% nitrogen (N₂), 20.95% oxygen (O₂), 0.93% argon (Ar), 0.038% carbon dioxide (CO₂), trace amounts of other gases, and a variable amount (average around 1%) of water vapor. At ambient temperatures, the oxygen and nitrogen gases in air will not react with each other. However, in an internal combustion engine, combustion of a mixture of air and fuel produces combustion temperatures high enough to drive endothermic reactions between atmospheric nitrogen and oxygen in the flame, yielding various oxides of nitrogen, such as nitric oxide (NO) and nitrogen dioxide (NO₂). Mono-nitrogen oxides such as NO and NO₂ are typically referred to by the generic term NOₓ. NO_{y} (reactive odd nitrogen) is defined as the sum of NOₓ plus the compounds produced from the oxidation of NOₓ which include nitric acid (HNO₃) and peroxyacetyl nitrate (PAN).

NO₂ is a major pollutant in the atmosphere of modem cities that is easily recognized by its reddish brown color. NO₂ is formed when NO is produced as a byproduct of combustion in internal combustion engines and power generators at temperatures greater than 800° C. and is oxidized by alkyl peroxy radicals in the atmosphere. In California, a principal source of NO₂ is from trucks, since auto emissions have been successfully reduced by use of catalytic converters. NO₂ in the troposphere subsequently undergoes photolysis to ultimately form O₃ in the presence of sunlight. In the stratosphere, however, NO₂ is implicated in the destruction of O₃. Mixing ratios for NO₂ have been measured at sub-parts-per-billion levels in remote areas and up to hundreds of parts per billion (ppb) in urban areas.

Nitrous oxide (N₂O) is a major greenhouse gas. While its radiative warming effect is substantially less than carbon dioxide (CO₂), N₂O's persistence in the atmosphere, when considered over a 100 year period, per unit of weight, has 310 times more impact on global warming than an equal per mass unit of CO₂. Control of N₂O is part of efforts to curb greenhouse gas emissions. Despite its relatively small concentration in the atmosphere, N₂O is the fourth largest greenhouse gas contributor to overall global warming, behind CO₂, methane (CH₄) and water vapor. The other nitrogen oxides contribute to global warming indirectly, by contributing to tropospheric ozone production during smog formation.

Agriculture is the main source of human-produced N₂O: cultivating soil, the use of nitrogen fertilizers, and animal waste handling can all stimulate naturally occurring bacteria to produce more N₂O. The livestock sector (primarily cows, chickens, and pigs) produces 65% of human-related N₂O. Industrial sources make up only about 20% of all anthropogenic sources, and include the production of nylon and nitric acid, and the burning of fossil fuel in internal combustion engines.

While various techniques have been developed to measure atmospheric NO₂ and N₂O, the techniques have results that suffer because of interference from other atmospheric constituents. As a result, the measured atmospheric NO₂ and N₂O are not accurate. Consequently, a technique to measure atmospheric NO, NO₂, and N₂O that is free from interferences from other atmospheric constituents is needed.

### SUMMARY OF THE INVENTION

A method for quantifying nitrogen-containing species from an atmospheric sample, including: (i) introducing the atmospheric sample into an NO₂-analyzer to obtain a first measurement; (ii) subjecting the atmospheric sample to thermal decomposition followed by introducing the atmospheric sample into the NO₂-analyzer to obtain a second measurement; (iii) subjecting the atmospheric sample to ozone titration and thermal decomposition followed by introducing the atmospheric sample into the NO₂-analyzer to obtain a third measurement; (iv) subjecting the atmospheric sample to excess ozone followed by introducing the atmospheric sample into the NO₂-analyzer to obtain a fourth measurement; (v) subjecting the atmospheric sample to excess nitrogen monoxide followed by introducing the atmospheric sample into the NO₂-analyzer to obtain a fifth measurement; (vi) subjecting the atmospheric sample to a catalyst at an elevated temperature with added excess NO and introducing the atmospheric sample into the NO₂-analyzer to obtain a sixth measurement wherein nitrogen monoxide is added to the sample to convert dinitrogen oxide (N₂O) to nitrogen dioxide (NO₂) at a temperature of between 100 to 400 degrees Celsius; and (vii) subjecting the atmospheric sample to a catalyst at elevated temperature followed by ozone titration and thermal decomposition followed by introducing the atmospheric sample into the NO₂-analyzer to obtain a seventh measurement.

In one embodiment, the difference between the first measurement and the fourth measurement represents the level of nitrogen dioxide (NO₂) in the atmospheric sample; the difference between the second measurement and the first measurement represents the level of peroxyacetyl nitrates (PANs) in the atmospheric sample; the difference between the third measurement and the second measurement represents the level of nitrogen monoxide (NO) in the atmospheric sample; the fourth measurement represents the level of water in the atmospheric sample; the difference between the fifth measurement and the first represents the level of ozone (O₃) in the sample; the difference between the sixth measurement and the first measurement represents the level of dinitrogen monoxide (N₂O) in the atmospheric sample; and the difference between the seventh measurement and the first measurement represents the level of ammonia (NH₃) in the atmospheric sample.

In one embodiment, subjecting the atmospheric sample to ozone titration includes subjecting the atmospheric sample to a 10% excess to a 10,000 fold excess ozone to sample and subjecting the atmospheric sample to nitrogen monoxide titration includes subjecting the atmospheric sample to nitrogen oxide (NO) with a 10% excess to 11,000 fold excess of nitrogen monoxide. In one embodiment, subjecting the atmospheric sample to thermal decomposition includes introducing the atmospheric sample to a heated reaction chamber for a time period between 1 minute and 2 minutes, the heated reaction chamber at a temperature between 100 degrees Celsius and 400 degrees Celsius with or without added ozone or nitrogen oxide. According to some embodiments the measurements are taken in series or in parallel. Also, according to some embodiments, the NO₂-analyzer is one of cavity ring down spectroscopy (CRDS), continuous wave-CRDS (cw-CRDS), off-axis cw-CRDS or cavity attenuated phase shift spectroscopy (CAPS).

A system for quantifying nitrogen-containing species from an atmospheric sample, including a gas phase titration system and an NO₂-anaylzer in fluid communication with the gas phase titration system is herein disclosed. In one embodiment, the gas phase titration system includes an ozone generator, a nitrogen oxide source or nitrogen oxide generator, and a heated reaction chamber in series wherein the heated reaction chamber has a high surface area. Also, according to some embodiments, the NO₂-analyzer is one of cavity ring down spectroscopy (CRDS), continuous wave-CRDS (cw-CRDS), off-axis cw-CRDS or cavity attenuated phase shift spectroscopy (CAPS).

A method for measuring a level of NOₓ from an atmospheric sample, including: (i) mixing the atmospheric sample with ozone; (ii) subjecting the mixture to heat; and (iii) passing the mixture through an NO₂-anaylzer to obtain a NOₓ level in the atmospheric sample is herein disclosed. Mixing the atmospheric sample with ozone includes titrating the atmospheric sample to a 10% excess to 11,000 fold excess of ozone to sample. Subjecting the mixture to heat includes introducing the atmospheric sample to a heated reaction chamber for time period between 1 minute and 2 minutes. Also, according to some embodiments, the NO₂-analyzer is one of cavity ring down spectroscopy (CRDS), continuous wave-CRDS (cw-CRDS), off-axis cw-CRDS or cavity attenuated phase shift spectroscopy (CAPS). In one embodiment, dilution of the sample reduces side reactions with hydrocarbons and lowers the water vapor concentration to avoid condensation.

### BRIEF DESCRIPTION OF THE DRAWINGS

FIG. 1 is a graph of a typical cavity ring down spectroscopy (CRDS) signal measuring a sample of clean air.

FIG. 2 illustrates a CRDS system according to an embodiment of the invention.

FIG. 3 illustrates a cavity ring-down absorption spectrum of NO₂, taken with 17.7 ppb of NO₂ in 1 atm clean air, compared with the absorption spectrum taken by Yoshino et al. with pure NO₂ at 0.5-3.0 Torr.

FIG. 4 illustrates a diagram of a gas phase titration system 400 used to measure NO₂ in the atmosphere without any of the interferences according to an embodiment of the invention.

FIG. 5 is a diagram of analysis showing components of air at the top and the combination of species measured by each type of analytic step on the right.

FIG. 6 is a diagram representing a system to detect nitrogen-containing compounds from an atmospheric sample in series.

FIG. 7 is a diagram representing a system to detect nitrogen-containing compounds from an atmospheric sample in parallel.

FIG. 8 is a graph comparing NO₂ measurements taken by CRDS and a NOₓ analyzer on pure NO₂ standards in clean air.

FIG. 9 is a graph illustrating ambient NO₂ measurements and the daytime variations of NO₂ concentration on the campus of University of California, Riverside, Calif., on Tuesday, Nov. 15, 2005.

FIG. 10 is a graph illustrating ambient NO₂ measurements and the daytime variations of NO₂ concentration on the campus of University of California, Riverside, Calif., on Thursday, Nov. 17, 2005.

FIG. 11 illustrates an embodiment of an annular denuder which may be used with embodiments of the invention.

FIG. 12 is a graph illustrating NO₂ and NO_{y} measurements according to one example of the present invention.

FIG. 13 is a table illustrating the thermodynamic analysis associated with FIG. 12.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

One commonly used method of measuring atmospheric nitrogen dioxide (NO₂) is chemiluminescence in which conversion of NO₂ to nitric oxide (NO), either by catalytic thermal decomposition (which suffers from interferences from organic nitrates, HNO₃, etc.) or photolysis (which is relatively immune from interferences), is followed by reaction of NO with ozone (O₃) to produce electronically excited NO₂*. The excited NO₂* emits a broad continuum radiation in the region of 500-900 nanometers (nm), with a signal strength that is proportional to the concentration of NO. Subtraction of the background NO concentration then yields the concentration of NO₂.

Chemiluminescence of NO by reaction with ozone (O₃) is used extensively for quantifying NO and NO₂ in industrial smoke stack emissions, air quality monitoring stations and medical facilities, but suffers from quenching by water vapor and, at high enough concentrations, from CO₂, as well as leading to erroneously low readings by remaining energy from excited NO₂ instead of produced light. An additional problem for NO₂ measurements using chemiluminescence is that catalytic thermal conversion of NO₂ to NO for detection together as NOₓ (where x equals 1 and/or 2) can lead to high NO₂ readings from other nitrogen-containing species, such as acyl peroxynitrates (PANs), alkyl nitrates and ammonia (NH₃) that produce NO₂ upon thermal decomposition. This additional signal has resulted in NOₓ analyzers being termed NO_{y} analyzers because they measure more than the sum of NO and NO₂. In the presence of quenching, the analyzers can actually indicate significantly less pollution as well. As a result, accurate measurements of NO₂ using the prior art approach of chemiluminescence cannot be obtained.

In addition to the prior art approach of chemiluminescence, several NO₂ specific analyzers with low limits of detection have been demonstrated using techniques including cavity ring-down spectroscopy (CRDS) and its derivatives, i.e., continuous wave cavity ring-down (cw-CRDS), off-axis cw-CRDS, cavity attenuated phase shift spectroscopy (CAPS), and cavity enhanced absorption spectroscopy (CEAS). Tunable diode laser spectroscopy (TDLAS) and laser induced fluorescence (LIF) are more established techniques that measure NO₂ and could also be combined with chemiluminescence. Unfortunately, none of these techniques is effective at measuring ambient NO directly due to NO's relatively weak vibrational bands and higher energy first electronic transition in the ultraviolet region of the spectrum. Moreover, water vapor interference is also present.

Embodiments of the invention overcome these problems with the prior art approaches and provide an inexpensive and effective method for conversion of trace gas sample NO to NO₂ for measuring atmospheric NO, NO₂, N₂O, and PANs. The present invention provides a system and method for using cavity ring-down spectroscopy (CRDS) or a related absorption method while substantially or completely minimizing interferences that are encountered in prior art approaches.

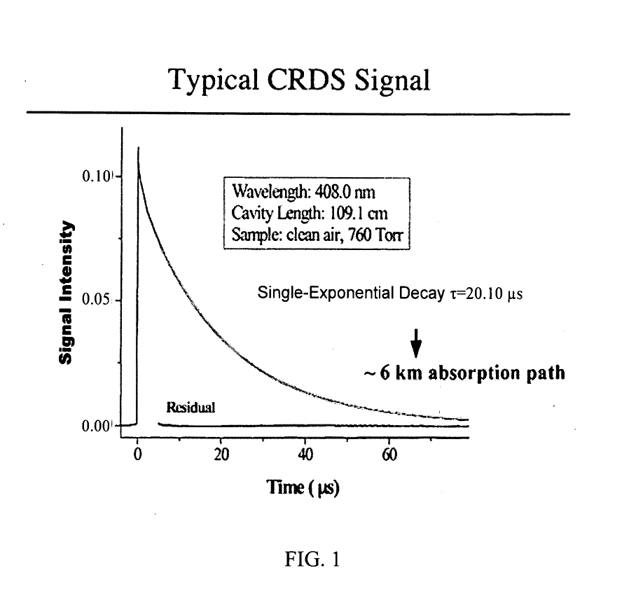

FIG. 1 illustrates a graph of a typical CRDS signal measuring a sample of clean air. CRDS is a sensitive spectroscopy technique that is based on measurements of the rate of attenuation rather than the magnitude of attenuation of the light by a sample. It can be used to measure the concentration of some light-absorbing substances, such as air pollutants. In CRDS, two ultra-high reflective mirrors face each other with a space (or cavity) in between. In the classic pulsed laser implementation, a brief pulse of light is injected into the cavity and bounces (i.e., “rings”) back and forth between the mirrors. Some small amount (typically around 0.1% or less) of the generated light enters and leaks out of the cavity and may be measured each time light hits one of the mirrors. Because some light is lost (i.e., leaks out) on each reflection, the amount of light hitting the mirrors is slightly less each time. Furthermore, as a percentage leaks through, the amount of light measured also decreases with each reflection. If the only loss factor in the cavity is the reflectivity loss of the mirrors, one can show that the light intensity inside the cavity decays exponentially in time with a decay constant tau (τ) (i.e., the “ring down time”). If a light-absorbing species is introduced into the cavity, the light will undergo fewer reflections before it disappears. In other words, CRDS measures the time it takes for the light to drop to a certain percentage of its original amount. The time change measured may be converted to a concentration.

As the absorption described above involves thousands of passes of light through the sample, the sensitivity is greatly enhanced leading to lower limits of detection. CRDS is a quantitative and absolute method and is capable of measuring species with previously measured absorption cross sections by taking the difference between the ring-down decay rate with sample (1/τ) and the background decay rate without sample (1/τ₀):

$$α = \frac{L}{{cl}_{s}} ( \frac{1}{τ} - \frac{1}{{τ}_{0}} ) = σ N$$

where α is the absorption coefficient, c is speed of light, L is the cavity length, and lₛ is the sample path length. The cross section is the effective area of light blocked by each molecule and is a fundamental property of each molecular absorber. The resulting absorption coefficient, α, can then be divided by the cross section (σ) to yield the concentration or number density (N). One benefit of this method is that errors in the measurement of 1/τ and 1/τ₀ at least partially cancel out during the subtraction. If the power of the laser drops or there is deposition on the mirrors, the signal intensity will decrease and the noise will increase, but the resulting calculation of the concentration remains relatively unchanged. If the absorbing species can be selectively removed from the sample stream, it becomes possible to obtain a measure of the concentration without any calibration gases.

In addition to the rate changes from transmittance through the mirrors and absorption, another prominent cause of light intensity loss inside the cavity during the ambient measurements is Rayleigh scattering by air. The cross-section for Rayleigh scattering can be approximated as

$${σ}_{Rayleigh} ( λ ) = \frac{8 {π}^{3}}{3} [ \frac{{( {n}^{2} - 1 )}^{2}}{{N}^{2} {λ}^{4}} ]$$

where n is the refractivity of air (n−1 equals tens to hundreds of parts per million), N is the number density of gas, and both n and N are dependent on the temperature and pressure.

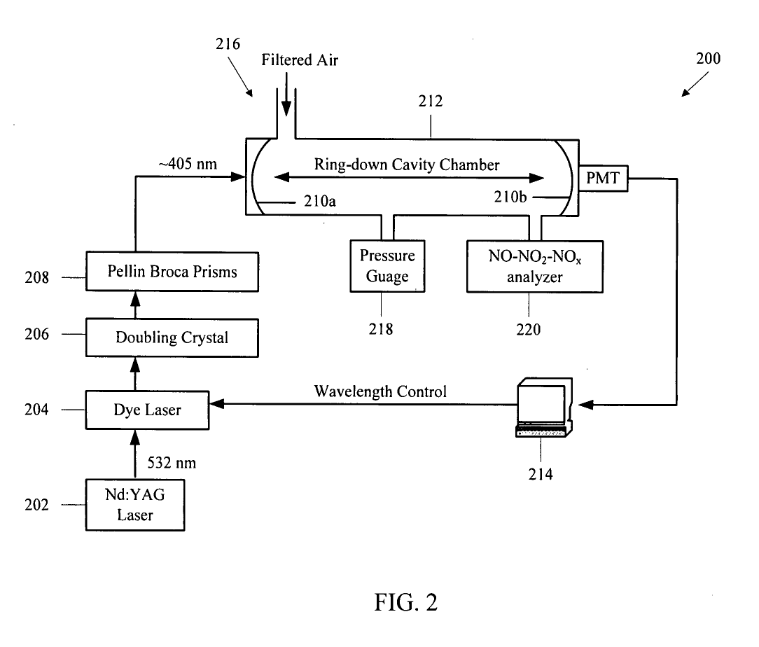

FIG. 2 illustrates a block diagram of a cavity ring-down laser absorption apparatus 200 for obtaining NO₂ measurements, according to one aspect of the present invention. Near-UV laser radiation (1-2 mJ/pulse, line width 0.2-0.3 cm⁻¹) is generated from frequency doubling the ˜800 nm output of a Nd:YAG (532-nm) 202 pumped dye laser 204, such as a LDS821 dye, by sending it through a doubling crystal 206. It then goes through a Pellin Broca prism 208 to separate a single required wavelength from a light beam containing multiple wavelengths.

A pair of cavity mirrors 210a and 210b are separated by approximately 109 centimeters (cm) and have reflectivity better than 99.985% at 405 nanometers (nm) (Research Electro-Optics, diameter=20 millimeters (mm), and ROC=1 meter (m)). The cavity ring-down time, r, varies from 25 microseconds (μs) down to 11 μs, depending on the ambient concentration of NO₂ and the alignment of the cavity chamber 212. The effective absorption path length is in the range of 4 to 8 kilometers (km). The laser wavelength is calibrated with a wave meter 214, such as a Burleigh Model WA-4500 wave meter, with accuracy of 0.001 nm at 800 nm and is also checked against the NO₂ reference spectra as described in “High-Resolution Absorption Cross Section Measurements of NO, in the UV and Visible Region” by Yoshino, K.; Esmond, J. R.; Parkinson, W. H. (Chem. Phys. 1997,221, 169-174), hereinafter referred to as “Yoshino et al.” The absorption of NO₂ at 405.23 nm is used for CRDS measurement of NO₂. This location, slightly off the absorption peak, has a more stable reading than at the crest of the peak.

The air sample 216 is drawn into the cavity chamber 212 using a flow rate of 0.25-1.0 liters per minute (L/min) through 30 feet (ft) of FEP tubing (¼ inch outer diameter (OD)). The pressure inside the absorption cell (i.e. cavity chamber 212) is monitored using a pressure gauge 218, such as a Granville-Phillips, Series 275. The resulting pressure will be slightly less than the local atmospheric pressure. A 0.45 μm particle filter is used to remove the particulates in the ambient air stream, thus minimizing particulate Mie scattering and to prevent possible deposition of particles on the surfaces of mirrors 210a and 210b. Buffer gases are not required to protect the mirror surfaces as long as the ambient air sample is sufficiently filtered.

The outlet of the CRDS cavity 212 is connected through approximately 8 ft of FEP tubing to a NO—NO₂—NOₓ analyzer 220, such as a Thermo Environmental Instruments Inc., model 42C, NO—NO₂—NOₓ analyzer, to cross-check the NO₂ concentrations. The NO—NO₂—NOₓ (chemiluminescence) analyzer utilizes a molybdenum oxide converter to reduce NO₂ to NO at 317° C. Standards of pure NO₂ in clean air with concentrations down to 10 ppb will be obtained by dynamic mixing of ultrahigh purity grade air with a certified standard NO₂-in-air mixture, such as Airgas, 4.02 ppm. Mixing is achieved by using a bubble flow meter calibrated mass flow meter and flow controller, such as an Aalborg GFC171S and GFM171. The response time of detection is limited by the pumping rate and the size of the sample chamber.

The concentrations of the NO₂ standard mixtures calculated from the dilution factors and the concentration of the certified standard are not considered to be reliable due to absorption of NO₂ in the gas cylinder, regulator, and plumbing; however, they can be accurately measured using the NO—NO₂—NOₓ analyzer.

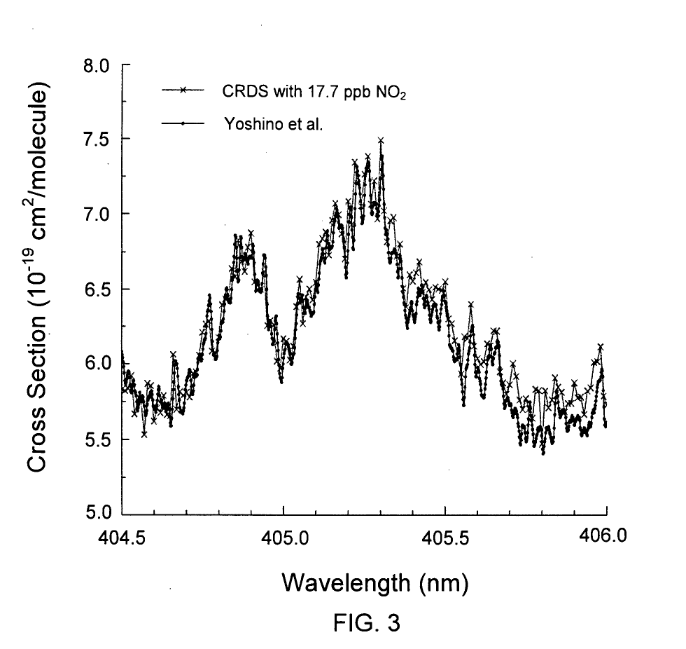

FIG. 3 illustrates a cavity ring-down absorption spectrum of NO₂, taken with 17.7 ppb of NO₂ in 1 atm clean air, compared with the absorption spectrum taken by Yoshino et al. with pure NO₂ at 0.5-3.0 Torr. The comparison shows good agreements in the absorption cross sections and spectrum features of NO₂ between the CRDS and traditional absorption spectroscopy and the greatly enhanced detection sensitivity in CRDS.

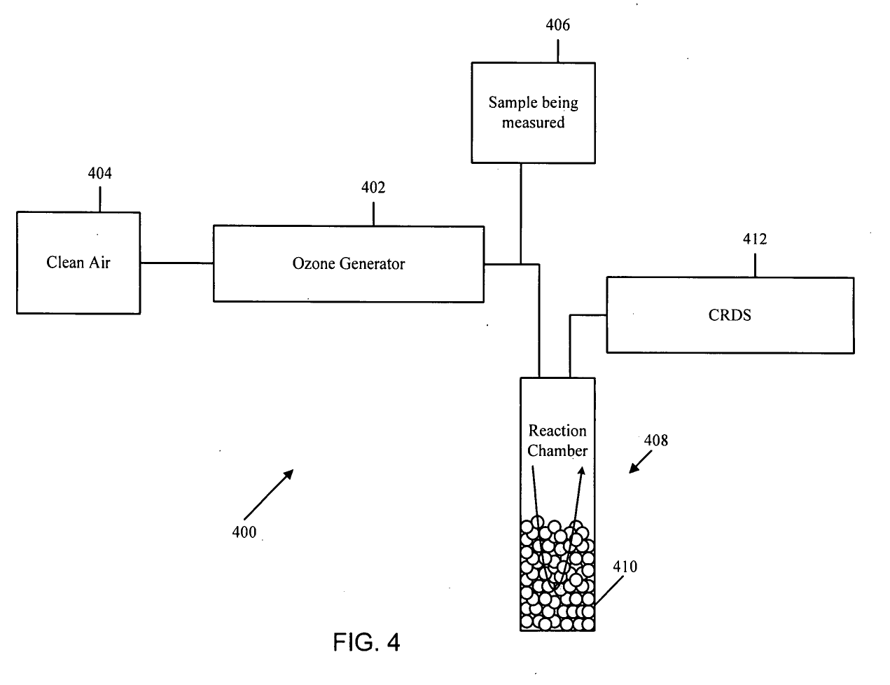

FIG. 4 illustrates a diagram of a gas phase titration system 400 which may be used in conjunction with an NO₂-analyzer to measure nitrogen-containing compounds in the atmosphere without any of the interferences according to one embodiment of the invention. As shown, the gas phase titration system 400 includes an ozone generator 402, such as a glow discharge apparatus or oxygen photolysis by a shortwave ultraviolet light source, both of which generate relatively low ozone concentrations. In glow discharge, air is broken down by a high AC potential across what is effectively an air and glass dielectric capacitor. With glow discharge, it is possible to mix the resulting ozone at low flow rates relative to the sample flow rate and still obtain a significant amount of ozone so that the sample dilution by the ozone stream is insignificant. In one embodiment, the gas phase titration system 400, in conjunction with an NO₂-analyzer, may be used to measure the level of NO in a sample. The following are representative chemical equations of the reaction of NO with ozone (to form NO₂ for measurement by the NO₂-analyzer) using glow discharge:

O₂→2O,

O+O₂=O₃,

NO+O₃→NO₂+O₂

The NO₂ formed can react further with excess amount of ozone as shown by the following representative chemical equations:

NO₂+O₃→NO₃+O₂,

NO₃+NO₂→N₂O₅

To generate ozone, clean air 404 may be introduced into the ozone generator 402. A sample 406 of the atmosphere being measured may be mixed with the generated ozone in a heated reaction chamber 408 at a low enough mixing ratio to not perturb the total sample size. For example, the ratio may be from about 10% excess to 11,000 fold excess of ozone to sample. To avoid loss of the sample due to N₂O₅ deposition, mixing occurs at elevated temperatures (unless a background signal is desired). For this, the heated reaction chamber 408, which includes a high surface area, may be used. For example, the heated reaction chamber 408 may be filled with beads 410. In one embodiment, the chamber may be hard anodized aluminum with a sapphire-like protective layer or fluoropolymer coating. Such material may offer sufficiently equivalent chemical resistance as glass without the potential for breakage that exists with glass. The beads may be replaced with Raschig rings or porous materials such as ceramics, zeolites, or fritted glass without altering the nature of the invention. To maintain the sample at elevated temperature long enough for the ozone and N₂O₅ to decompose, a 1 to 2 minute residence time within the heated reaction chamber 408 may be used. In addition to making the formation of N₂O₅ unfavorable, the heated reaction chamber 408 also facilitates the decomposition of N₂O₅ and excess ozone to produce a signal of NO_{y} that is measured by the NO₂-analyzer (i.e., detector) as NO₂.

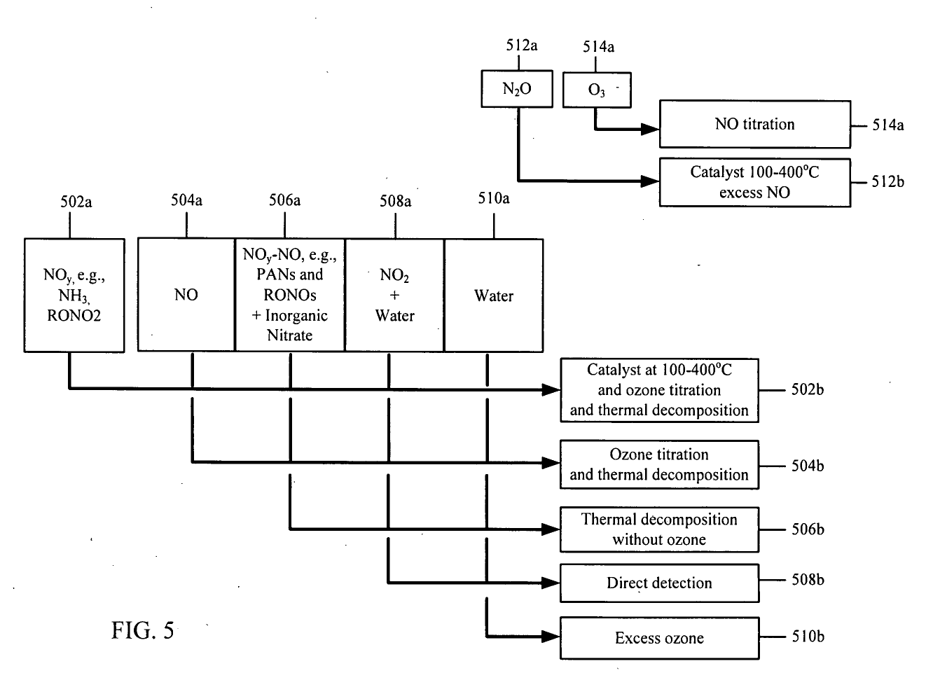

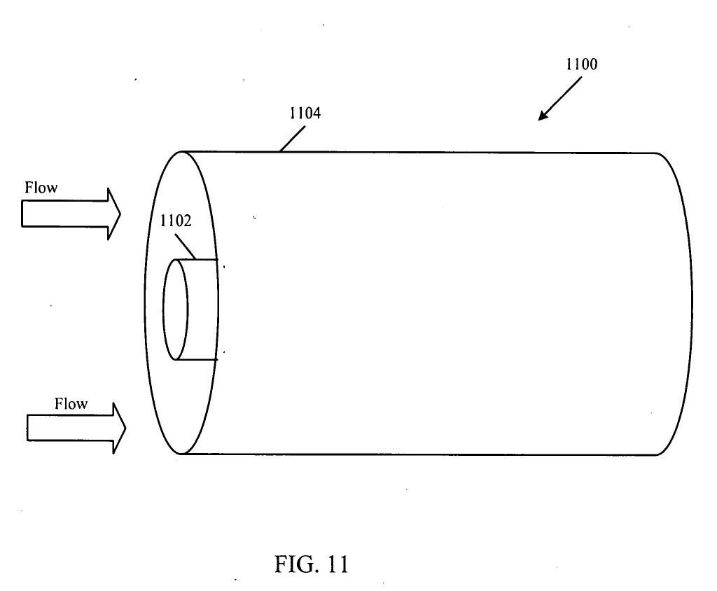

Embodiments of the invention allow for the measurement of different nitrogen-containing compounds within a sample by carrying out different analytic steps either in series or in parallel. FIG. 5 is a diagram of analysis showing components of air at the top and the combination of species measured by each type of analytic step at the right for the system of FIG. 4. Differences between the analytic steps allow measurements of different nitrogen-containing compounds, i.e., NH₃ and RONO₂, NO, PANs, NO₂, N₂O in addition to water and ozone. For example, the level of PANs can be measured as follows: an NO₂ signal with thermal decomposition without ozone titration (506b) represents NO₂ in the air sample, possible NO₂ converted from PANs due to thermal decomposition in the glass beads 410, and the background from interfering species such as water. The sample is passed through the heated reaction chamber 408 with glass beads 410 with no ozone titration, and then enters into the CRDS cavity 412. The NO₂-analyzer measures the NO₂ present in the sample, additional NO₂ from the PANs that have been converted to NO₂ by heat, and any water vapor interference. The combination of NO₂ and any water interference can then be measured separately by bypassing the heater (508b), giving a difference that represents the level of PANs. The water interference is then measured independently by adding excess ozone (O₃) to remove NO₂ (510b). Alternatively, water interference may be removed by adding a Permapure drying tube or equivalent dryer at the inlet. To measure the level of NO, the sample can be measured with thermal decomposition with ozone titration (504b). The difference of the measured signal with thermal decomposition plus ozone titration (504b) and with thermal decomposition without ozone titration (506b) gives the NO level. An alternative way of measuring the baseline with just water vapor present is to use a denuder (see FIG. 11) coated with sodium hydroxide and guiacol or sodium hydroxide and activated charcoal to remove NO₂. Additionally, the sample can be subjected to a catalyst with thermal decomposition (100-400° C.) with excess NO (512a) and introduced into the analyzer to obtain a measurement. The different between this measurement (512b) and the measurement obtained by direct detection of NO2 with thermal decomposition of PANs (508b) represents the level of N₂O. Finally, the sample can be subjected to NO titration (514a) and introduced into the analyzer to obtain a measurement. The different between this measurement (514b) and the measurement obtained by direct detection of NO₂ with thermal decomposition of PANs (508b) represents the level of O₃. Accordingly, the various analytic steps allow measurement of the separate NO, NO₂, NOₓ, PANs, N₂O and NO_{y} levels in addition to ozone and water.

To summarize, a sample can be subjected to the following analytic steps to obtain levels of the various nitrogen-containing compounds within the sample: a sample 406 may be introduced directly into the CRDS system 200 (see FIG. 2) at 405.23 nm or 440 nm for measurement of NO₂ and any interferences (508b). The sample 406 may preferably be introduced at room temperature. Next, the sample 406 may be introduced into heated reaction chamber 410 followed by introduction into the CRDS system 200 for measurement of NO₂ and PANs (506b). Next, the sample 406 may be titrated with excess ozone (O₃) by the gas titration system 400 followed by introduction into the CRDS system 200 to measure NO (504b). If the ozone is turned up to a higher level, all of the NOₓ is lost due to the formation of N₂O₅ which deposits on most surfaces. This step allows for a background check that includes any interference signal from water vapor and other substances, e.g., carbon dioxide (510b). Next, the sample 404 may be passed through a precious metal or metal oxide catalyst such as platinum or molybdenum oxide (MoO₃) converter at 100 to 400° C. to produce a traditional NO_{y} signal, e.g., representing levels of NH₃, RONO₂ and N₂O (502b).

At least one difference between this technique and chemiluminescence is that water is an additive interference that can be subtracted and not a source of possibly variable levels of quenching. As a result, more accurate NO, NO₂, N₂O NOₓ, NH₃, O₃, PANs, and NO_{y} levels may be obtained. That is, obtaining separate measurements, i.e., (i) a measurement obtained without the heated reaction chamber 408 to get NO₂ plus background, (ii) a measurement obtained with the heated reaction chamber 408 to get NO_{y}—NO (e.g., PANs), (iii) a measurement obtained with a catalyst at elevated temperature, slight excess ozone and thermal decomposition to get NO_{y} (e.g., NH₃, RONO), (iv) a measurement obtained with over-excess ozone to get background signal (e.g., water, carbon dioxide), (v) a measurement obtained with ozone titration and thermal decomposition, (vi) a measurement obtained with a catalyst at elevated temperature and NO titration, and (vii) a measurement obtained with NO titration, subtraction and recombination of the levels provides zero calibration NO levels, NO₂ levels, NOₓ levels and NO_{y} levels, all in one analyzer.

This technique results in reliable ambient NOₓ readings that are free from interferences or quenching. Additionally, by also allowing the reaction to take place at room temperature by increasing the flow of ozone (O₃), no signal from NO₂ is obtained due to the formation of N₂O₅ which deposits on most surfaces allowing for a background check that includes any interference signal from water vapor and other substances. In this way, a gas phase titrator can be added to any of these methods to measure NO, NO₂, N₂O NOₓ, NH₃, O₃, PANs, and NO_{y} with automatic baseline correction and elimination of interferences. In the cases of CRDS, cw-CRDS, off axis cw-CRDS and CAPS, it might be possible to rely on the known absorption cross section of NO₂ to obtain valid readings without any calibration gases once the analyzer has been adequately proven to give reliable readings. The only additional gases needed are a supply of adequately cleaned air for the ozone generator, and any necessary dilution for high concentration applications to obtain the lower concentrations these analyzers optimally detect.

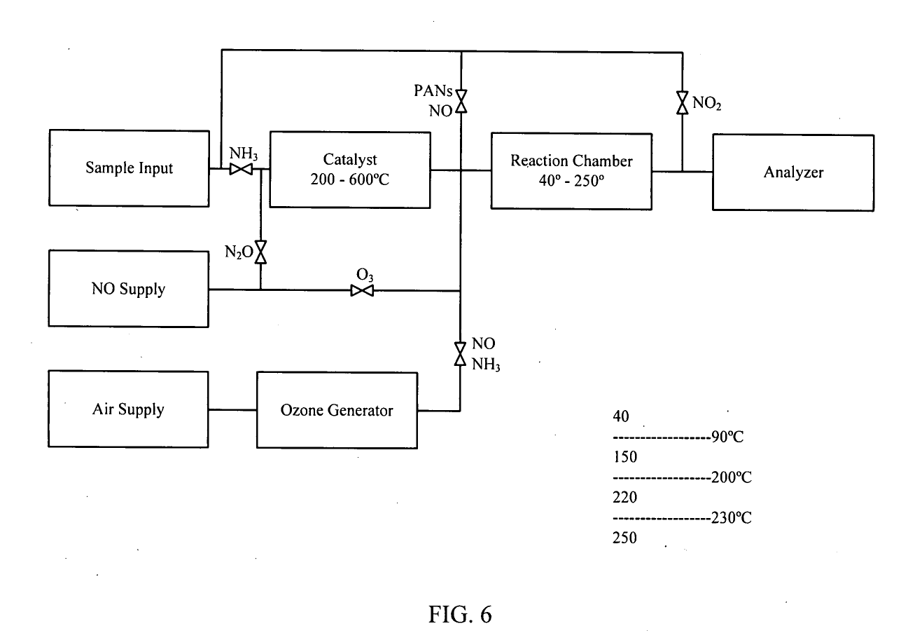

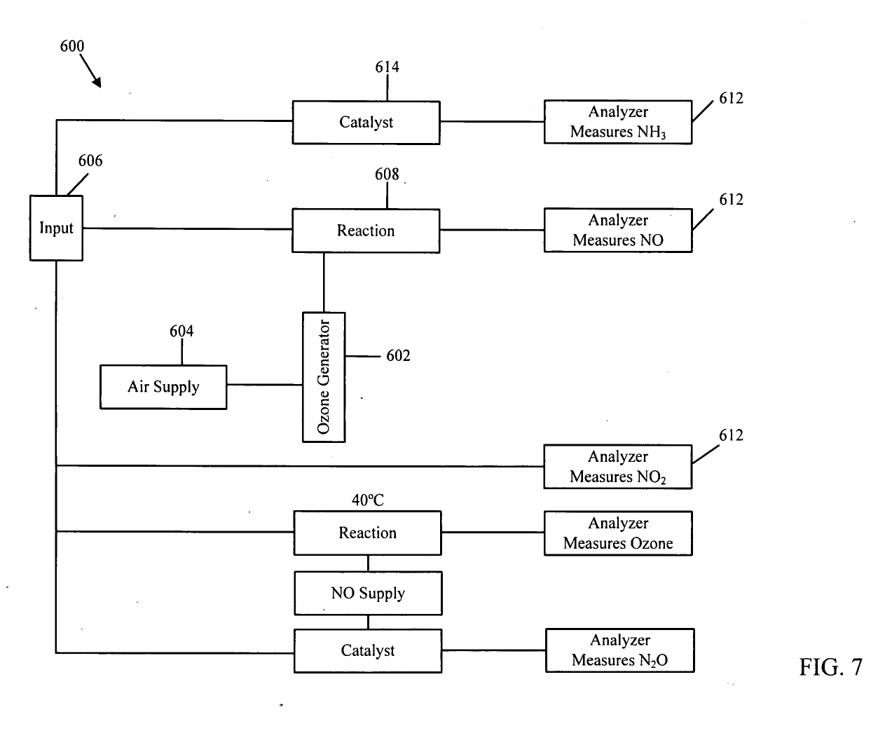

FIG. 6 is a diagram representing a system to detect nitrogen-containing compounds from an atmospheric sample in series. The system 600 includes a sample input chamber 606 which is in-line with a gas phase titration system including air supply 604 and ozone generator 602; a reaction chamber 608; a catalyst chamber 614; and an NO₂-analyzer 612. Additional reaction chamber(s) and/or catalyst chamber(s) can be added in parallel without changing the nature of the measurements. The various valves 616 may be opened or closed to bypass or open certain pathways depending on the measurement desired. For example, a method for quantifying nitrogen-containing species from an atmospheric sample may include introducing the atmospheric sample directly into an NO₂-analyzer 612 to obtain a first measurement. Then, the sample may be subjected to thermal decomposition in reaction chamber 608 (about 150° C.) followed by introducing the atmospheric sample into the NO₂-analyzer 612 to obtain a second measurement. Then, the sample may be subjected to ozone titration by ozone generator 602 (about 1.1:1 to about 11,000:1 ozone:sample) and thermal decomposition in reaction chamber 604 (about 150° C.) followed by introducing the atmospheric sample into the NO₂-analyzer 612 to obtain a third measurement. Then, the sample may be subjected to a large excess of ozone of approximately 100,000:1 by ozone generated from ozone generator 602 followed by introducing the atmospheric sample into the NO₂-analyzer 612 to obtain a fourth measurement. The sample may be titrated with nitrogen monoxide (NO) to obtain a fifth measurement. Finally, the sample may be subjected to a catalyst (e.g., platinum or MoO₃ at between 100 to 400° C.) with or without the presence of excess NO at an elevated temperature and with and without ozone titration and thermal decomposition followed by introducing the atmospheric sample into the NO₂-analyzer to obtain a sixth and seventh measurement, respectively. The difference between the first measurement and the fourth measurement represents the level of NO₂ in the atmospheric sample. The difference between the second measurement and the first measurement represents the level of PANs in the atmospheric sample. The difference between the third measurement and the second measurement represents the level of NO in the atmospheric sample. The fourth measurement represents the level of water in the atmospheric sample. The difference between the fifth measurement and the first measurement represents the level of ozone in the sample. The difference between the sixth measurement and the first measurement represents the level of dinitrogen monoxide (N₂O) in the sample and the difference between the seventh measurement and the first measurement represents the level of ammonia (NH₃) in the sample. FIG. 7 is a diagram representing a system of FIG. 6 to detect nitrogen-containing compounds from an atmospheric sample in parallel.

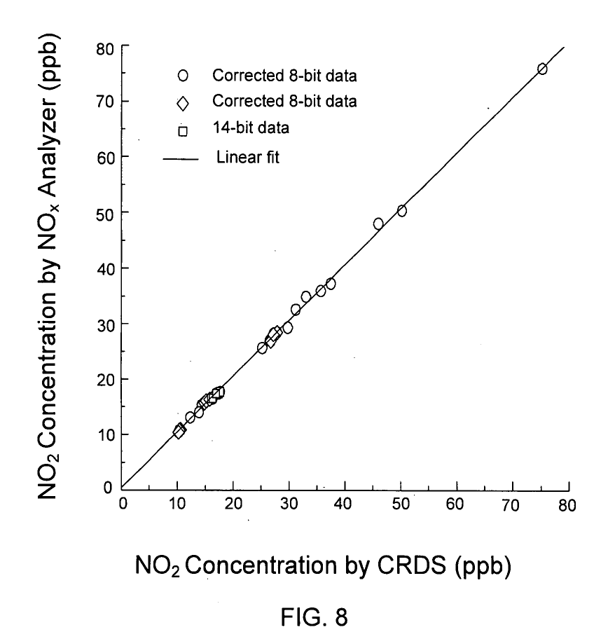

FIG. 8 is a graph comparing NO₂ measurements taken by CRDS and a NOₓ-analyzer on pure NO₂ standards in clean air. In this comparison, the gas samples are passed through the CRDS cavity for the CRDS measurements and then entered into the NOₓ analyzer; the CRDS NO₂ concentrations are obtained using the measured absorption coefficients by CRDS and the known NO₂ absorption cross sections as described in Yoshino et al. The CRDS and NOₓ analyzer measurements of the pure NO₂ standards in clean air in the concentration range of 10-100 ppb will be in excellent agreement, as shown in FIG. 3.

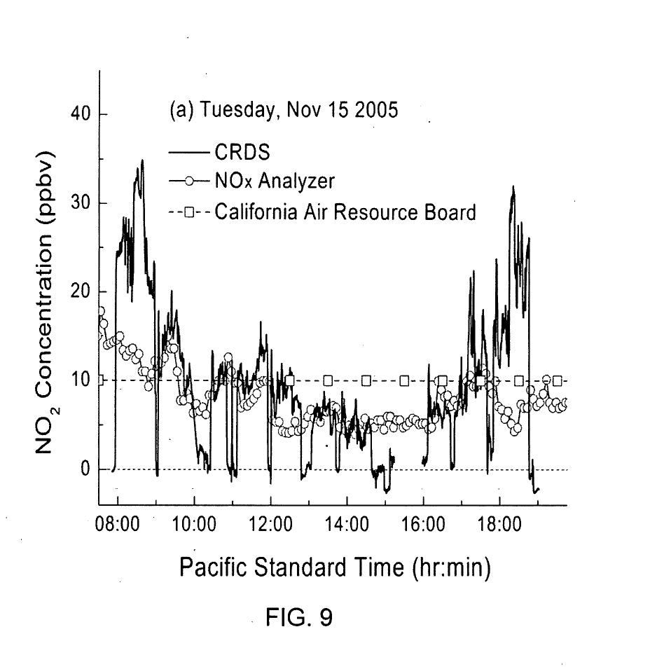

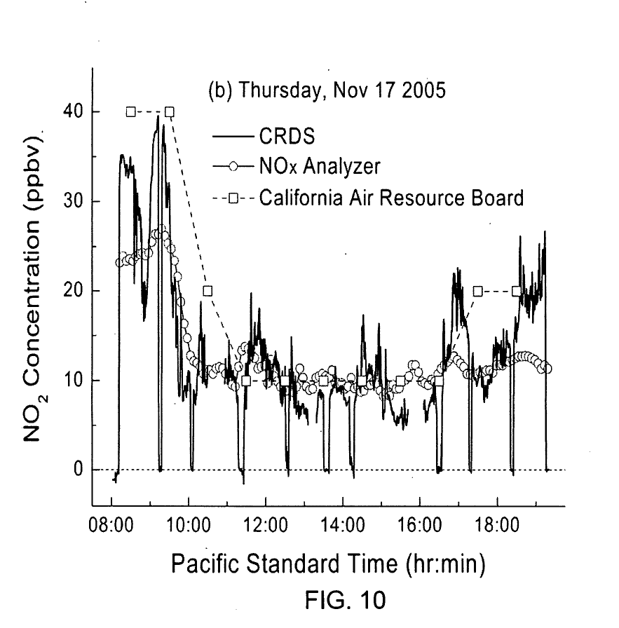

FIGS. 9-10 are graphs illustrating ambient NO₂ measurements and the daytime variations of NO₂ concentration on the campus of University of California, Riverside, Calif., on Tuesday, Nov. 15, 2005 (FIG. 7), and Thursday, Nov. 17, 2005 (FIG. 8). Samples were obtained by drawing ambient air in through Teflon tubing that ran through a hole in a windowsill of a laboratory and extended 3 ft from the side of the building with support from a metal structure. The CRDS measurements were taken every 10 seconds by averaging 100 ring-down decay rates using the 14-bit data acquisition card. Periodically, the NO₂ denuder and filter system was inserted into the sample line before the CRDS cavity, and the background without NO₂ (i.e., the contributions from water vapor and/or other interferences and the Rayleigh scattering of air was recorded. The reported ambient NO₂ concentrations were obtained from the total CRDS signal levels minus the background level. As shown in FIGS. 7-8, the CRDS NO₂ measurements were periodically dropped to baseline (which was set to zero) with a denuder and filter in order to report the NO₂ concentrations; in this approach, the baseline was also checked for possible drift due to the ambient conditions (temperature, pressure, etc.), and it was shown to be reasonably stable for a period of 12 hours. The CRDS NO₂ data were compared to the available online NO₂ measurements (based on the chemiluminescence analyzer) taken by the California Air Resources Board (CARB) (with hourly average) at Mount Rubideaux approximately, 6 km to the west, and to a chemiluminescence analyzer (with 5 min time resolution), located 0.5 km to the south. On Thursday, Nov. 17, 2005, there was reasonable agreement among the three sites during midday with some significant divergence in the mornings and evenings. On Tuesday, Nov. 15, 2005, the agreement was poor, especially with the CARB measurements.

The temporal profile of the ambient NO₂ concentration, as shown in the CRDS data in FIGS. 9-10, is consistent with the effect of sunlight causing reduced NO₂ levels during peak photochemical activity at midday and with higher NO, levels in the morning and during the night when the traffic on nearby freeways causes relatively high NO₂ levels. The significantly lower NOₓ analyzer reading of the ambient NO₂ in the mornings and evenings might be due to water vapor quenching.

The detection sensitivity can be improved by increasing the input laser intensity and averaging over more laser shots with a high repetition pulsed laser or frequently cycled continuous wave (cw) laser or light emitting diode to reduce the standard deviation, by increasing the cavity length to increase the absorption loss and by using mirrors with higher reflectivity. It was thought that better results would be obtained with the 14-bit oscilloscope card, but experiments comparing 8-bit to 14-bit resolution found that the 8-bit oscilloscope contributed slightly less noise than the 14-bit data acquisition card to the final readings. This difference might be partially due to the different methods of signal averaging (fitting the ring-down curve after 32 events averaging in the 8-bit method vs. fitting every single curve and averaging the resulting ring down time in the 14-bit method).

The usage of a cw diode laser or a light emitting diode (emitting around 400 nm) in a cw-CRDS instrument for NO₂ measurement may have some advantages over the use of a pulsed laser. This would result in a relatively compact instrument, increased signal-to-noise ratio in ring-down transient due to the potential to operate at much higher repetition rates, and better mechanical stability.

An alternate method of background correction involves the selective removal of NO₂, by an annular denuder 1100. The annular denuder may be comprised of an eight inch long quarter inch rod 1102 inside three eighths glass tubing 1104 coated with basic activated charcoal or sodium hydroxide (NaOH) and guiacol. A filter prevents particles of the coating from entering the analyzer (see FIG. 11). NO₂ specific analyzers are not sufficiently sensitive to measure ambient NO₂ levels when the use of ozone and thermolysis for gas phase titration was first proposed for automotive exhaust. Additionally, for stack gasses and auto exhaust, it is now possible to dilute the samples to the point where hydrocarbon interference would be negligible and still measure the NO₂.

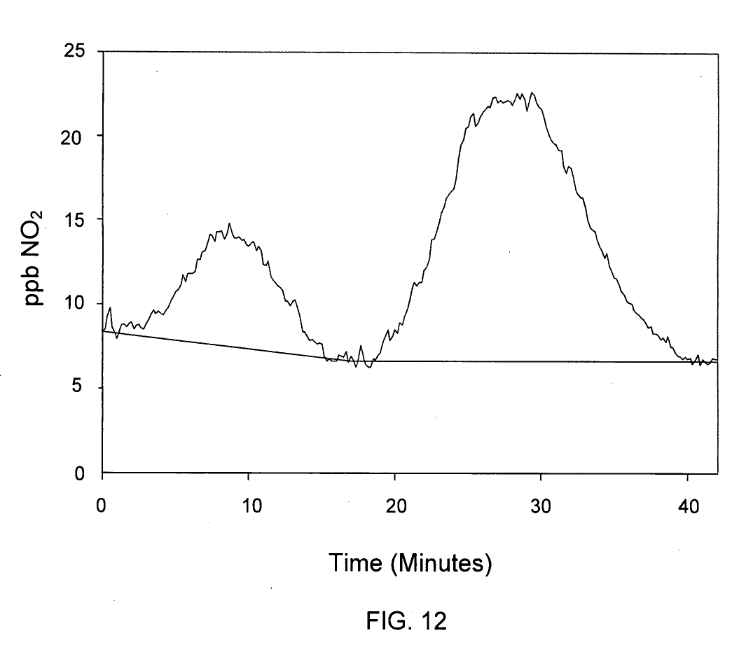

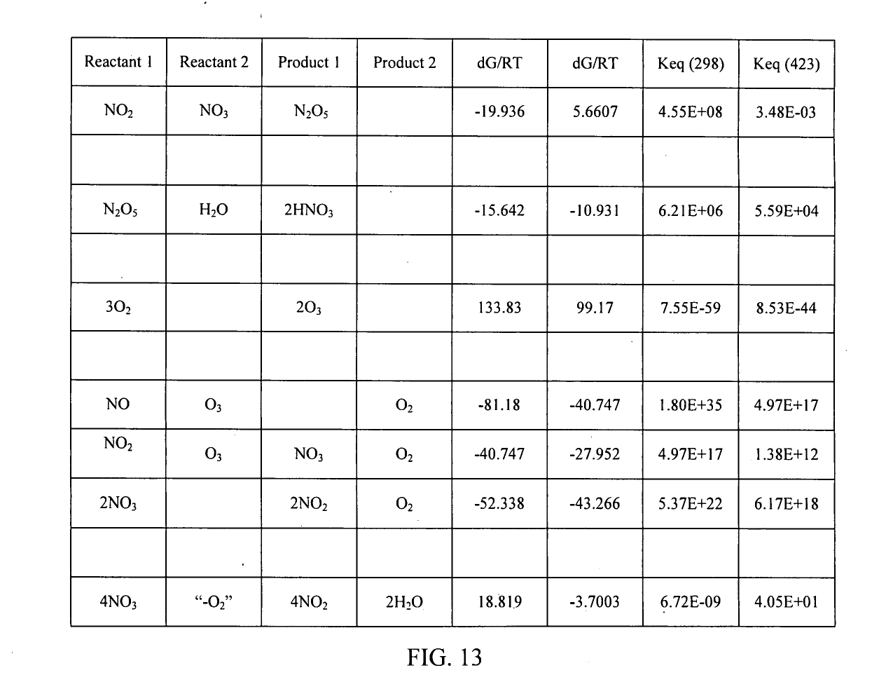

FIG. 12 is a graph illustrating NO₂ and NO_{y} measurements, according to one example of the present invention. A 6.7-8.4 ppb equivalent baseline is consistent with water interference for ambient relative humidity at 48% of 29.4° C., and was taken by turning up the ozone flow-rate to the point that N₂O₅ formed in the tee connecting ozone to the sample. After turning off the ozone, a 6.5 ppb NO₂ signal is present. Turning the ozone to an intermediate value gives a 15.4 ppb NOₓ signal resulting in an 8.9 ppb signal from NO. PANs were not detectable at the time of the measurement but would be expected to result in a difference between the NO₂ signal with and without the glass bead heater. California Air Resources Data taken 6 km upwind showed a 7 ppb response to NO₂ but no measured NO suggesting possibly that quenching put the NO level below the limit of detection and the combined reading of NO and NO₂ at 7 ppb. The baseline drift is due possibly to changes in humidity and/or thermal expansion of the sample cell. FIG. 13 is a table illustrating the thermodynamic analysis.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. A method for quantifying nitrogen-containing species from an atmospheric sample, comprising:
introducing the atmospheric sample into an NO₂-analyzer to obtain a first measurement;
subjecting the atmospheric sample to thermal decomposition followed by introducing the atmospheric sample into the NO₂-analyzer to obtain a second measurement;
subjecting the atmospheric sample to ozone titration and thermal decomposition followed by introducing the atmospheric sample into the NO₂-analyzer to obtain a third measurement;
subjecting the atmospheric sample to an additional excess of ozone of 10 to 1000 times more followed by introducing the atmospheric sample into the NO₂-analyzer to obtain a fourth measurement;
subjecting the atmospheric sample to excess nitrogen monoxide followed by introducing the atmospheric sample into the NO₂-analyzer to obtain a fifth measurement;
subjecting the atmospheric sample to a catalyst at an elevated temperature with added excess NO and introducing the atmospheric sample into the NO₂-analyzer to obtain a sixth measurement wherein nitrogen oxide is added to the sample to convert dinitrogen oxide (N₂O) to nitrogen dioxide (NO₂) at a temperature of between 100 to 400 degrees Celsius; and
subjecting the atmospheric sample to a catalyst at elevated temperature followed by ozone titration and thermal decomposition followed by introducing the atmospheric sample into the NO₂-analyzer to obtain a seventh measurement.

2. The method of claim 1 wherein the difference between the first measurement and the fourth measurement represents the level of nitrogen dioxide (NO₂) in the atmospheric sample.

3. The method of claim 1 wherein the difference between the second measurement and the first measurement represents the level of peroxyacetyl nitrates (PANs) in the atmospheric sample.

4. The method of claim 1 wherein the difference between the third measurement and the second measurement represents the level of nitric oxide (NO) in the atmospheric sample.

5. The method of claim 1 wherein the fourth measurement represents the level of water in the atmospheric sample.

6. The method of claim 1 wherein the fifth measurement represents the level of ozone (O₃) in the atmospheric sample.

7. The method of claim 1 wherein the difference between the sixth measurement and the first measurement represents the level of dinitrogen monoxide (N₂O) in the atmospheric sample.

8. The method of claim 1 wherein the difference between the seventh measurement and the first measurement represents the level of ammonia (NH₃) in the atmospheric sample.

9. The method of claim 1 wherein subjecting the atmospheric sample to ozone titration comprises subjecting the atmospheric sample to a ratio of between 10% excess to 11,000 fold excess ozone to the sample.

10. The method of claim 1 wherein subjecting the atmospheric sample to nitrogen monoxide (NO) titration comprises subjecting the atmospheric sample to a ratio of between 10% excess to 11,000 fold excess nitrogen monoxide to the sample.

11. The method of claim 1 wherein subjecting the atmospheric sample to thermal decomposition comprises introducing the atmospheric sample to a heated reaction chamber for a time period between 1 minute and 2 minutes, the heated reaction chamber at a temperature between 100 degrees Celsius and 500 degrees Celsius with or without added ozone or nitrogen oxide.

12. The method of claim 1 wherein the measurements are taken in series.

13. The method of claim 1 wherein the measurements are taken in parallel.

14. The method of claim 1 wherein the NO₂-analyzer is one of cavity ring down spectroscopy (CRDS), continuous wave-CRDS (cw-CRDS), off-axis cw-CRDS or cavity attenuated phase shift spectroscopy (CAPS).

15. A system for quantifying nitrogen-containing species from an atmospheric sample, comprising:
a gas phase titration system; and
an NO₂-anaylzer in fluid communication with the gas phase titration system.

16. The system of claim 15 wherein the gas phase titration system comprises an ozone generator, a nitrogen oxide source or nitrogen oxide generator, and a heated reaction chamber in series.

17. The system of claim 16 wherein the heated reaction chamber has a high surface area.

18. The system of claim 15 wherein the NO₂-analyzer is one of cavity ring down spectroscopy (CRDS), continuous wave-CRDS (cw-CRDS), off-axis cw-CRDS or cavity attenuated phase shift spectroscopy (CAPS).

19. A method for measuring a level of NOₓ from an atmospheric sample, comprising:
mixing the atmospheric sample with ozone;
subjecting the mixture to heat; and
passing the mixture through an NO₂-anaylzer to obtain a NOₓ level in the atmospheric sample.

20. The method of claim 19 wherein mixing the atmospheric sample with ozone comprises titrating the atmospheric sample to a ratio of between 0.01% and 10% ozone to sample.

21. The method of claim 19 wherein subjecting the mixture to heat comprises introducing the atmospheric sample to a heated reaction chamber for time period between 1 minute and 2 minutes.

22. The method of claim 19 wherein the NO₂-analyzer is one of cavity ring down spectroscopy (CRDS), continuous wave-CRDS (cw-CRDS), off-axis cw-CRDS or cavity attenuated phase shift spectroscopy (CAPS).

23. The method of claim 19 wherein dilution of a non-atmospheric sample to ambient levels of pollutants reduces side reactions with hydrocarbons and lowers the water vapor concentration to avoid condensation wherein the non-atmospheric sample comprises auto exhaust or smokestack exhaust.
